(19) United States
(12) Patent Application Publication
(10) Pub. No.: US 2006/0041724 A1
(43) Pub. Date: Feb. 23, 2006

(54) Locked cache line sharing

(76) Inventors: Simon C. Steely JR., Hudson, NH (US); Stephen R. Van Doren, Northborough, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/920,759

(22) Filed: Aug. 17, 2004

(51) Int. Cl. G06F 12/00

(52) U.S. Cl. 711/144; 711/145; 711/138

(57) ABSTRACT

A technique to share cache lines among a plurality of bus agents. Embodiments of the invention comprise at least one technique to allow a number of agents, such as a processor or software program being executed by a processor, within a computer system or computer network to access a locked (“owned”) cache line, under certain circumstances, without incurring as much of the operational overhead and resulting performance degradation of many prior art techniques.

### FIELD OF INVENTION

Embodiments of the invention described herein relate to cache memory. More particularly, embodiments of the invention relate to a technique for sharing a locked cache line among one or more agents within a computer system or network.

### BACKGROUND

Typical prior art caching schemes allow critical programs and bus agents within computer systems to access lines of cache that are locked or “owned” by another program or agent using techniques involving significant overhead in terms of processing operations and time. Furthermore, prior art caching schemes typically require even more overhead in order to return ownership to the original program or agent once the critical program or agent has used the data from the cache line.

For example, one prior art cache line sharing technique allows an agent or program to gain access to a locked cache line by forcing the owned cache line into a shared state, or invalid state in some instances. After the requesting program or agent is through with the cache line, the requesting agent must release ownership of the line and the original owner must re-acquire ownership. Each of the above steps involved in transitioning ownership of the cache line involves various operations, which take time and processing resources. The problem is exacerbated when there are a number of requesting agents each waiting for ownership of a particular locked cache line.

Accordingly, prior art cache line sharing techniques can have adverse affects on computer system performance.

### BRIEF DESCRIPTION OF THE DRAWINGS

Claimed subject matter is particularly and distinctly pointed out in the concluding portion of the specification. The claimed subject matter, however, both as to organization and method of operation, together with objects, features, and advantages thereof, may best be understood by reference to the following detailed description when read with the accompanying drawings in which:

FIG. 1 illustrates an arrangement of bus agents in which at least one embodiment of the invention may be used.

FIG. 2 illustrates a cache line description buffer in which information may be stored useful in one embodiment of the invention.

FIG. 3 illustrates a point-to-point (PtP) network of bus agents in which at least one embodiment of the invention may be used.

FIG. 4 is a flow diagram illustrating operations that may be used in at least one embodiment of the invention.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail so as not to obscure the claimed subject matter.

Embodiments of the invention comprise at least one technique to allow a number of agents, such as a processor or software program being executed by a processor, within a computer system or computer network to access a locked (“owned”) cache line, under certain circumstances, without incurring as much of the operational overhead and resulting performance degradation of many prior art techniques. In at least one embodiment, a cache line sharing technique involves cache states, corresponding control logic, and a cache line description buffer to keep track of information about the line. In other embodiments, other implementations may be realized that do not necessarily use all of these components. Furthermore, additional components may be used to realize other embodiments of the invention.

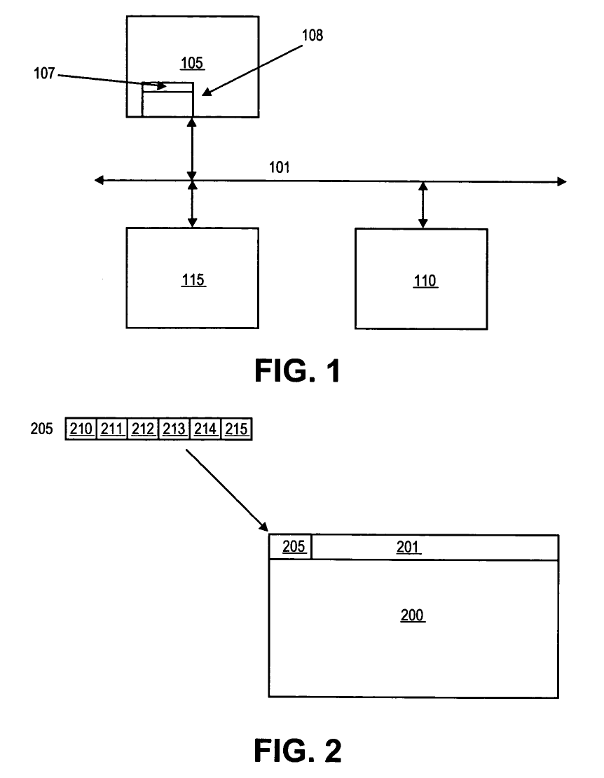

FIG. 1 illustrates an arrangement of bus agents in which at least one embodiment of the invention may be used. Particularly, FIG. 1 illustrates a bus 101 over which a number of bus agents communicate. In one embodiment, the processor “A” 105 has locked, or “owns”, cache line 107 in cache 108, whereas graphics device 110 and processor “B” 115 may attempt to access the locked cache line. Processor A may have acquired ownership of the cache line through executing an instruction, such as a “lock-acquire” instruction, which places the line in a state that allows other bus agents to access the line without resorting to the operational overhead of various prior art techniques.

For example, in one embodiment the line is placed in a state after a lock-acquire instruction is executed that allows processor B and/or the graphics device to receive an uncached version, or “copy”, of the data in the locked cache line. Furthermore, processor B and the graphics device may detect that the line is in the proper state to access an uncached version of the line, in one embodiment of the invention, by detecting information stored in a line description buffer corresponding to the locked cache line. Furthermore, the line description buffer may contain a record of all cache agents that have requested access to the locked cache line, in some embodiments. In other embodiments, the graphics device and processor B may detect the locked cache line state through other means, such as a look-up table. Furthermore, in other embodiments processor A may keep track of what agents have accessed the locked line through other means as well.

A bus agent receiving an uncached copy of the locked data line may store the copy in a state to indicate that the line is uncached, in at least one embodiment, using a line descriptor entry within the receiving bus agent's cache. Receiving an uncached copy of the locked line may allow an agent, such as processor B or the graphics device of FIG. 1, to perform operations, such as looped instructions, that may depend upon the locked line data. For example, in one embodiment of the invention, processor A and/or the graphics device of FIG. 1 may perform a software program loop that reads the uncached line data. However, if the software program running on either processor B or the graphics device performs other operations outside the loop, such as a forward branch or memory access, the uncached line state may transition to another state rendering the uncached line invalid.

The locked line stored in processor A's cache, in FIG. 1, may transition out of the state allowing other agents to access an uncached copy, in one embodiment, if the line is written to either by processor A or another bus agent. If the locked cache line transitions out of the state allowing other bus agents to access an uncached copy, the agent, such as processor A, owning the locked cache line may detect from the line's description buffer whether any other agents in the system have obtained an uncached copy. If other agents have obtained an uncached copy, in one embodiment, the owning agent, such as processor A, may inform the agents having an uncached copy of the line that the line has been changed and may also provide the changed line to the agents having an uncached copy before or after releasing the lock on the line.

Alternatively, the agent owning the cache line may pass the line to one of the agents that obtained an uncached copy and a list, from its description buffer, of all other agents that have an uncached copy, thereby allowing the agent to which the locked line was passed to invalidate the other agents' uncached copy, or it may just invalidate the uncached copies held by all agents other than the agent to which the owned line was provided. In other embodiments, other techniques may be used to manage the state of uncached copies after a write to the locked line has occurred.

An agent receiving the owned cache line may change the state of its uncached line copy to indicate that the agent now owns the cache line, in one embodiment. Furthermore, the cache line may then be used to satisfy a loop being executed by the agent receiving the owned cache line. In some embodiments, a counter may be used to terminate the uncached lines after a certain amount of time or upon an event, such as a context switch, in order to allow other agents or software threads to have access to the cache line.

FIG. 2 illustrates a cache line descriptor buffer containing various cache line descriptor entries that may exist or otherwise be associated with a locked cache line and/or a cache line containing an uncached copy of the locked cache line, according to one embodiment of the invention. Associated with each line 200 of cache 201 is a cache line buffer 205 that contains various cache line descriptor entries 210-215. In one embodiment, the cache line descriptor entries include a tag 210 to indicate an address to which the cache line corresponds, a state entry 211 to indicate, among other things, whether the line is in a locked state that may be accessed by other agents seeking an uncached copy or whether the line is an uncached copy, as well as various pointers 212-215 to indicate other bus agents that may have uncached copies of the cache line. Although in the embodiment illustrated in FIG. 2 the cache line description buffer contains 4 pointers, more or fewer pointers may be used in other embodiments of the invention.

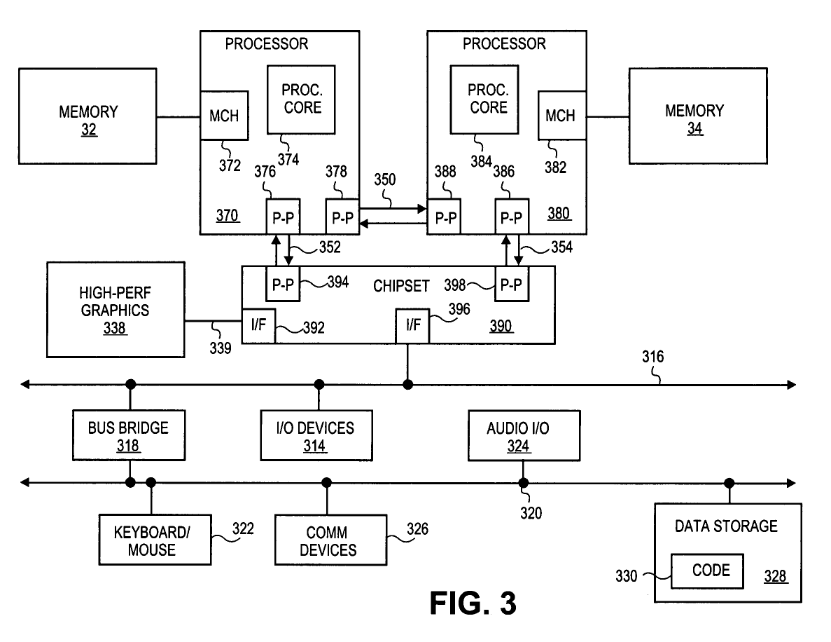

FIG. 3 illustrates a computer system that is arranged in a point-to-point (PtP) configuration. In particular, FIG. 3 shows a system where processors, memory, and input/output devices are interconnected by a number of point-to-point interfaces.

The system of FIG. 3 may also include several processors, of which only two, processors 370, 380 are shown for clarity. Processors 370, 380 may each include a local memory controller hub (MCH) 372, 382 to connect with memory 22, 24. Processors 370, 380 may exchange data via a point-to-point (PtP) interface 350 using PtP interface circuits 378, 388. Processors 370, 380 may each exchange data with a chipset 390 via individual PtP interfaces 352, 354 using point to point interface circuits 376, 394, 386, 398. Chipset 390 may also exchange data with a high-performance graphics circuit 338 via a high-performance graphics interface 339.

At least one embodiment of the invention may be located within the PtP interface circuits within each of the PtP bus agents of FIG. 3. Other embodiments of the invention, however, may exist in other circuits, logic units, or devices within the system of FIG. 3. Furthermore, other embodiments of the invention may be distributed throughout several circuits, logic units, or devices illustrated in FIG. 3.

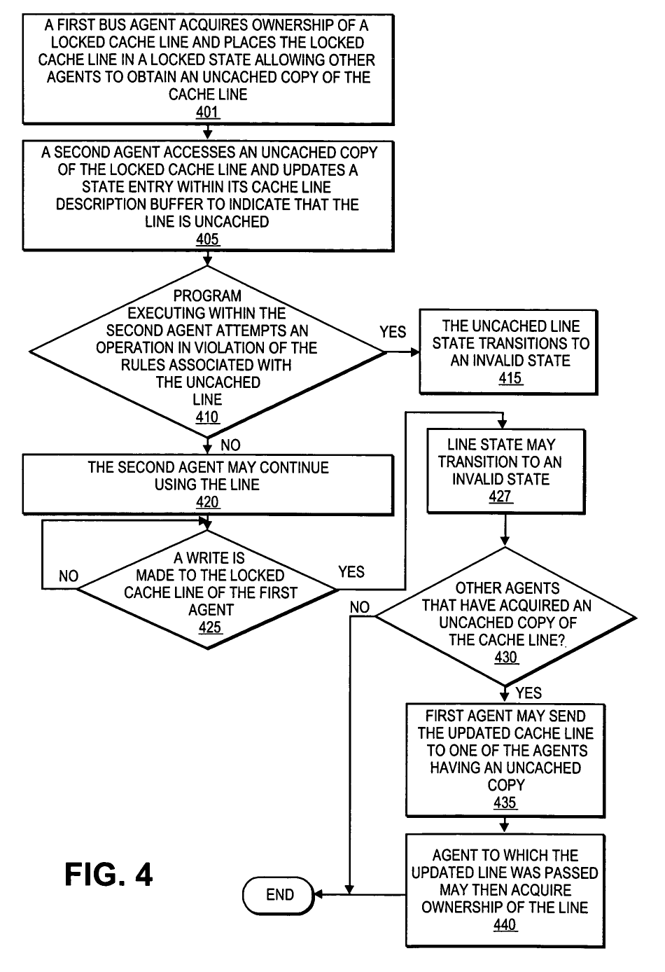

FIG. 4 is a flow diagram illustrating operations used in conjunction with at least one embodiment of the invention. Specifically, FIG. 4 illustrates operations performed in placing a cached line in a locked state, accessing the locked line, and transitioning ownership of the locked line, according to one embodiment of the invention. At operation 401, a first bus agent acquires ownership of a locked cache line and places the locked cache line in a locked state allowing other agents to obtain an uncached copy of the cache line. In one embodiment this is accomplished by updating a state entry within a cache line description buffer associated with the line. At operation 405, a second agent accesses an uncached copy of the locked cache line and updates a state entry within its cache line description buffer to indicate that the line is uncached and therefore carries certain restrictions on a program segments that use the line, such as certain jumps or memory accesses. If a program executing within the second agent attempts an operation in violation of the rules associated with the uncached line, at operation 410, the uncached line state transitions to an invalid state at operation 415. Otherwise, the second agent may continue using the line at operation 420, such as in a program loop.

If a write is made to the locked cache line of the first agent at operation 425, the line state may transition to an invalid state at operation 427. If the locked line transitions to an invalid state, the first agent may examine the locked cache line's description buffer to see if there are agents that may have acquired an uncached copy of the cache line at operation 430. In one embodiment, agents having uncached copies of the cache line are indicated by pointers within the locked cache line descriptor entry. If the first agent determines that other agents in the system have uncached copies of the locked line, then the first agent may send the updated cache line to one of the agents having an uncached copy, such as the second agent, at operation 435 as well as indicate to the agent having an uncached copy the other agents that have uncached copies. The agent to which the updated line was passed may then acquire ownership of the line, at operation 440, and satisfy any programs that it may be running that depend on the cache line. Alternatively, after a write occurs to the locked cache line of the first agent, the first agent may provide the updated cache line to all other agents having an uncached copy and allow some other arbitration scheme to determine which of the agents may acquire ownership of the updated cache line. In other embodiments, other techniques may be used to update agents having an uncached copy of the cache line.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

1. A method comprising:
placing a cache line into a locked state in which the cache line may be accessed among at least one other bus agent;
providing an uncached version of the cache line to the at least one other bus agent;
indicating to the at least one other bus agent whether the cache line has been modified.

2. The method of claim 1 further comprising providing to the at least one other bus agent an indicator of other cache agents that have accessed the cache line while it was in a locked state.

3. The method of claim 2 wherein the cache line is placed into an unlocked state when data is written to the cache line.

4. The method of claim 3 wherein the uncached version is invalidated if a program in which the uncached version is used performs an operation that violates rules associated with the uncached version.

5. The method of claim 4 wherein the rules consist of one or both of: performing a forward jump operation, performing a memory access.

6. The method of claim 5 wherein the at least one other bus agent assumes ownership of the cache line after the cache line is unlocked.

7. The method of claim 6 wherein the at least one other bus agent indicates to other bus agents having an uncached version of the cache line whether the at least one other bus agent has ownership of the cache line.

8. An apparatus comprising:
a cache line description buffer corresponding to a first bus agent to own the corresponding cache line, the cache line description buffer including an entry to indicate that the corresponding cache line is locked but may be accessed by other bus agents as uncached data.

9. The apparatus of claim 8 wherein the cache line description buffer further comprises at least one pointer to do indicate at least one other bus agent having an uncached version of the corresponding cache line.

10. The apparatus of claim 9 wherein the cache line description buffer further comprises a tag to identify the corresponding cache line.

11. The apparatus of claim 10 wherein the at least one other bus agent comprises a cache line descriptor entry to indicate whether the at least one other bus agent has an uncached version of the corresponding cache line.

12. The apparatus of claim 11 wherein the cache line description buffer corresponding to the first bus agent comprises an entry to indicate whether the corresponding cache line is invalid due to a write to the cache line.

13. The apparatus of claim 12 wherein the cache line description buffer corresponding to the at least one other bus agent comprises an entry to indicate whether the at least one other bus agent has ownership of the corresponding cache line.

14. The apparatus of claim 13 wherein the first bus agent and the at least one other bus agent are a microprocessor.

15. The apparatus of claim 14 wherein the first bus agent is a microprocessor and the at least one other bus agent is a graphics device.

16. A system comprising:
a first bus agent to own a cache line;
a second bus agent to access an uncached version of the cache line without changing the state of the cache line.

17. The system of claim 16 wherein the cache line corresponds to a first cache line descriptor indicating which agents have an uncached version of the cache line.

18. The system of claim 17 wherein the cache line corresponds to a state descriptor to indicate to the second bus agent to the second bus agent that the second bus agent may not cache a copy of the cache line without invalidating the cache line.

19. The system of claim 16 wherein the second bus agent comprises a cache line state entry to indicate whether the second bus agent has an uncached version of the cache line.

20. The system of claim 19 wherein the cache line state entry indicates the uncached version of the cache line is invalid if a program loop being executed by the second bus agent performs an operation outside of the loop.

21. The system of claim 18 wherein the cache line is to be invalidated if a write to the cache line occurs.

22. The system of claim 21 wherein the first bus agent is to pass ownership to the second bus agent if a write occurs to the cache line.

23. The system of claim 22 wherein the first bus agent is to provide an indicator of other bus agents having an uncached version of the cache line if the cache line is invalidated.

24. The system of claim 23 wherein the second bus agent is to lock the cache line if it is invalidated by the first bus agent and indicate to other bus agents in the system that the second bus agent owns the cache line.

25. A machine-readable medium having stored thereon a set of instructions, which if executed by a machine cause the machine to perform a method comprising:
performing a loop of operations;
reading an uncached version of a cache line during at least one iteration of the loop of operations;
performing an operation with an updated version of the uncached version if a write to the cache line occurs.

26. The machine-readable medium of claim 25 wherein the method further comprises losing access to the uncached version if the loop performs a forward jump operation.

27. The machine-readable medium of claim 25 wherein the method further comprises losing access to the uncached version if the loop performs a memory access operation.

28. The machine-readable medium of claim 25 wherein a processor executing the loop gains ownership of the updated cache line if a write to the cache line occurs.

29. The machine-readable medium of claim 26 wherein the uncached version is invalidated if a forward jump operation occurs.

30. The machine-readable medium of claim 27 wherein the uncached version is invalidated if a memory access occurs.
